(19) United States
(12) Patent Application Publication
(10) Pub. No.: US 2008/0091576 A1
(43) Pub. Date: Apr. 17, 2008

(54) Reimbursement Request System and Method

(76) Inventors: Ranjeev K. Teelock, Frisco, TX (US); Song Ma, Plano, TX (US); Bryan W. Lucas, Little Elm, TX (US); Cela J. Conners, Garland, TX (US); Matt Gilson, Weston, FL (US)

Correspondence Address: BAKER BOTTS L.L.P., 2001 ROSS AVENUE, SUITE 600, DALLAS, TX, 75201-2980, US

(21) Appl. No.: 11/765,184

(22) Filed: Jun. 19, 2007

Related U.S. Application Data
(60) Provisional application No. 60/815,196, filed on Jun. 19, 2006.

(51) Int. Cl. G06Q 10/00; G06F 17/00; G06Q 40/00

(52) U.S. Cl. 705/30; 705/1

(57) ABSTRACT

According to one embodiment, a system for validating one or more data records comprises a server that is coupled to a first computer and a second computer. The first computer is associated with a landlord and has the one or more records corresponding to one or more tenants. The second computer is associated with a performance-based contract administrator. The server is operable to receive a record from the first computer, transmit the record to the second computer for validation, and receive a response from the second computer. In the event that the response includes an error, the server is operable to transmit a help message to the first computer, where the help message is selected from a plurality of help messages in accordance with pertinence of the help message to the error.

### RELATED APPLICATIONS

This application claims the benefit of priority under 35 U.S.C. §119(e) of U.S. Provisional Application Ser. No. 60/815,196, filed Jun. 19, 2006, and entitled “REIMBURSEMENT REQUEST SYSTEM AND METHOD.”

### TECHNICAL FIELD

This invention relates to monetary reimbursement systems, and more particularly, to a reimbursement request system and method of operating the same.

### BACKGROUND

The United States Department of Housing and Urban Development (HUD) provides subsidized assistance for needy tenants in order to defray the costs associated with housing. In order to ensure that a tenant is subsidized an amount that is commensurate with his or her needs, HUD administers a set of guidelines that bases the amount of subsidy upon the status of the tenant. The status of the tenant may take into account the current income level, ongoing medical conditions, availability for work, number of dependents, or other such factors that may be used to determine the level of need of the tenant.

A tenant may be provided with a subsidy for a residential housing unit. A residential housing unit may comprise any suitable residential structure capable of providing a livable residence for a needy tenant. A residential housing unit may be, for example, a rental house, or a unit of an apartment complex or a multi-family housing complex.

HUD has delegated the administrative responsibility of managing subsidies to a number of performance-based contract administrators (PBCAs). The PBCAs may be located in various regions of the country in order to handle the needs of tenants that may be unique to their particular region. Responsibilities of a PBCA may include oversight of residential housing units, administration of subsidies to new and existing tenants, and reporting of current status reviews to HUD.

Under the rules provided by Section 8 of the United States Housing Act of 1937, a landlord may charge a reduced rate to a needy tenant and subsequently apply for reimbursement of the difference from HUD. The subsidies provided by HUD are then paid directly to each landlord via any suitable payment method, such as an automated clearing house (ACH) payment or a physical check. The needy tenant is only required to pay an amount that is not covered by the subsidy.

Conventionally, requests for subsidies of this type are provided by a system that transmits a data file to a PBCA on a periodic basis that may be, for example, once a month. The data file may include records associated with tenants seeking a subsidy from HUD. Typically, the data file is transmitted to the PBCA using electronic communication such as an Tenant Rental Assistance Compliance System e-mail messaging system (TRACSMail). To ensure that a landlord is reimbursed the appropriate amount, the PBCA validates each record according to the current status of the corresponding tenant. In the event that any information associated with any of the records is incorrect, an error message is transmitted back to the landlord.

If any of the records in the file has critical errors, the landlord is required to correct the critical errors and re-submit the file to the PBCA. This process has to be repeated in an iterative fashion until the records have no critical errors.

### SUMMARY OF THE DESCRIPTION

According to one embodiment, a system for validating one or more data records comprises a server that is coupled to a first computer and a second computer. The first computer is associated with a landlord and has access to the one or more records corresponding to one or more tenants. The second computer is associated with a performance-based contract administrator. The server is operable to receive a record from the first computer, transmit the record to the second computer for validation, and receive a response from the second computer. In the event that the response includes an error, the server is operable to transmit a help message to the first computer, where the help message is selected from a plurality of help messages in accordance with pertinence of the help message to the error.

According to another embodiment, a method for validating a data record by a server comprises receiving a record from a first computer associated with a landlord. The record is transmitted to a second computer associated with a performance-based contract administrator for validation. A response is received from the second computer. In the event that the response includes an error, a help message is transmitted to the first computer, where the help message is selected from a plurality of help messages in accordance with pertinence of the help message to the error.

Some embodiments of the present invention may provide numerous technical advantages. A technical advantage of one embodiment may be that a response may be provided to the client site in an interactive fashion, thus enabling a relatively quick resolution to any error that might be found. Additionally, the reimbursement system may provide help messages that may be directed to resolving the error. The messages may provide information describing the nature of the error and a possible resolution.

While specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description.

### BRIEF DESCRIPTION OF THE DRAWINGS

A more complete understanding of embodiments of the invention will be apparent from the detailed description taken in conjunction with the accompanying drawings in which:

FIG. 1 is a diagram of one embodiment of a reimbursement request system according to the present invention;

FIG. 2 is a block diagram of the data center of the embodiment of FIG. 1;

FIG. 3 is an illustrative view of an example project-based tenant record that may be used with the embodiment of FIG. 1;

FIG. 4 is an illustrative view of an example voucher record that may be used with the embodiment of FIG. 1;

FIG. 5 is an illustrative view an example of a set of common attributes that may be used with the embodiment of FIG. 1;

FIG. 6 is an illustrative view of an example interim vacancy record that may be used with the embodiment of FIG. 1;

FIG. 7 is an illustrative view of an example debt service record that may be used with the embodiment of FIG. 1;

FIG. 8 is an illustrative view of an example unpaid rent/damages record that may be used with the embodiment of FIG. 1;

FIG. 9 is an illustrative view of an example rent-up vacancy record that may be used with the embodiment of FIG. 1;

FIG. 10 is an illustrative view of an example dual occupancy test record that may be used with the embodiment of FIG. 1; and

FIG. 11 is a flow diagram of one embodiment of an example method that may be used with the reimbursement request system of FIG. 1.

### DETAILED DESCRIPTION OF EXAMPLE EMBODIMENTS

In the following description, reference is made to the accompanying drawings that illustrate embodiments of the present invention. It is to be understood that other embodiments may be utilized and structural and operational changes may be made without departing from the spirit and scope of the present invention.

Certain embodiments may alleviate many of the drawbacks of conventional reimbursement request systems. Conventional reimbursement request systems were burdensome for the landlord as well as for the PBCA. For example, full monetary reimbursement was received only after submission of a file having no critical errors. If errors were found, the landlord would receive an error message from the PBCA. The manner in which records were iteratively submitted and corrected typically resulted in a relatively long delay in receiving the reimbursement. Additionally, error messages were generally cryptic in nature, thereby requiring skilled personnel to understand and properly correct errors.

As will be described in greater detail below, certain embodiments provide a system and method for processing requests for reimbursement from HUD. According to one embodiment, a landlord may submit a file comprising one or more records. A record may have a number of attributes describing information about the tenant. The system may then sequentially submit the records to a pertinent PBCA for validation. In the event that an error message representing incorrect information is received from the PBCA, an error message may be immediately transmitted back to the landlord to facilitate correction of the error. The system may then transmit one or more help messages associated with the particular error message to the landlord. In one embodiment, these error messages may be provided to the landlord interactively such that the error causing the error message may be resolved in a relatively efficient manner.

The system may reduce the time to correct information by providing real-time feedback for incorrectly supplied information. Moreover, the system may provide an interactive help session by sending help messages that may help a landlord to correct incorrect information. The interactive nature of the system may allow the landlord to quickly identify the incorrect information, make appropriate corrections according to suggestions provided by the system, and then re-submit the information again for validation. Thus, the interactive process may enable the validation of tenant information in a relatively short period of time.

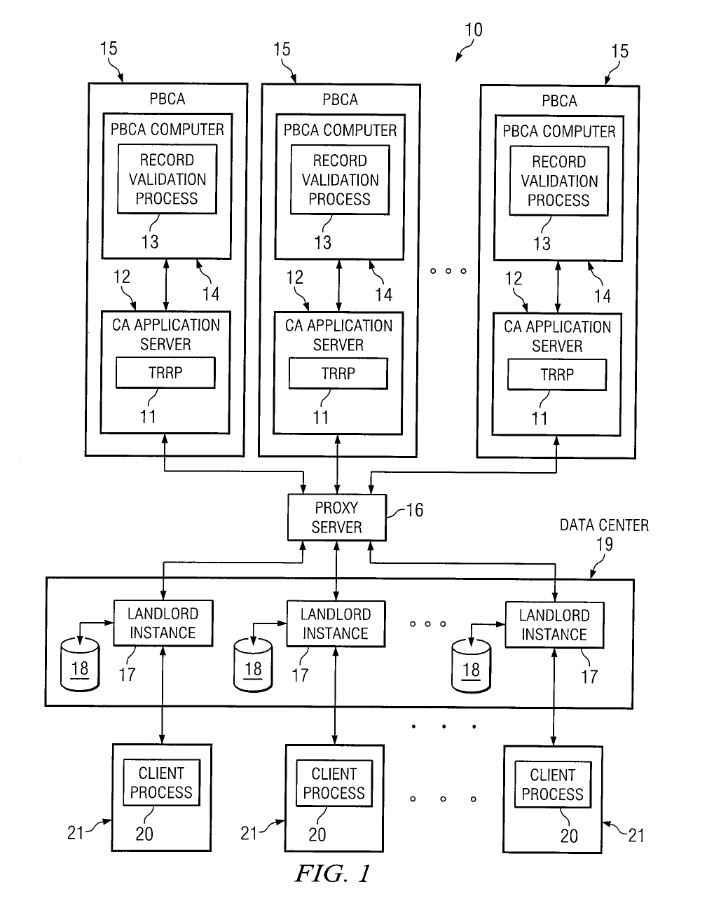

FIG. 1 shows one embodiment of a reimbursement request system 10 according to the present invention. The reimbursement request system 10 generally comprises a number of PBCA computers 14, a number of contract administrator application servers 12, a proxy server 16, a data center 19, and a number of landlord computers 21.

The PBCA computer 14 and the contract administrator application server 12 are located at the PBCA 15 and are coupled together using any suitable communications connection such as an Ethernet, token ring, or other similar type of connection. The proxy server 16 couples the contract administrator application server 12 to the data center 19 using a suitable connection that may be a network such as the Internet. The proxy server 16 may direct each record to the appropriate PBCA 15. The data center 19 in turn, is coupled to each of the landlord computers 21 via a suitable network such as the Internet.

Requests for validation of records are issued by one or more landlord computers 21. A landlord instance 17 corresponds to a client process 20 running on a landlord computer 21. Additionally, landlord instance 17 may have a database 18 for storing information regarding tenants. The data center 19 may interact with each of the landlord computers 21 using a client-server model. In one embodiment, the landlord computer 21 may be a personal computer, work station, laptop computer, desktop computer, personal digital assistant, or other similar type device that is capable of implementing the client process 20. In one embodiment, the client process 20 may be a web browser.

The contract administrator application server 12 has a tenant record request process (TRRP) 11 that is configured to validate one or more records according to information provided in the record. Validation of the one or more records is accomplished by submission of each record to a record validation process 13 running on the PBCA computer 14. In one embodiment, the record validation process 13 may have a validation service that is exposed through a portal such as a web service. The tenant record request process 11 may submit records for validation. In another embodiment, the record validation process 13 may comprise Housing Data System (HDS) software, available from Housing Data Systems, Inc. located in Weston, Fla.

According to aspects of particular embodiments of the present invention, the system 10 can also be used to provide for messages between the users of the client process 20 and an operator of the PBCA computer 14. The messages may comprise free form questions, answers, or other information. The messages can be communicated between users of the reimbursement request system 10 using the same data transfer mechanisms and protocols as those described above. In these particular embodiments, the reimbursement request system 10 provides real time interaction between users of the landlord computer 21 and the operator of the data center 19 and/or PBCA computer 14. This real time interaction may be provided by a messaging model in which messages generated by the landlord computer 21 are transmitted using a point-to-point type protocol to the data center 19 and queued at the data center 19 for response by the operator.

In one embodiment, the client process 20 may be executed on each of the landlord computers 21. In one embodiment, the client process 20 may function as a client and the landlord instance 17 may function as a server. The communication between the two may be facilitated using a protocol, such as Hyper Text Transfer Protocol (HTTP). In one embodiment, the landlord instance 17 and client process 20 may include OneSite Leasing & Rent-Affordable (HUD) software, version 3.0, available from RealPage, Inc., located in Carrollton, Tex.

The client process 20 may be provided as a thin client. The term “thin client” may refer to a particular type of client within a client-server architecture that primarily depends upon the server for processing activities. Thus, certain embodiments may provide advantage in that maintenance and periodic upgrades of software algorithms may be easily made in the server portion of the reimbursement request system 10. Client process 20 operating as a thin client may also allow for modification of executable software algorithms that implement the reimbursement request system 10 in the data center 19.

Modifications, additions, or omissions may be made to reimbursement request system 10 without departing from the scope of the invention. The components of reimbursement request system 10 may be integrated or separated. For example, proxy server 16 may be integrated with data center 19 such that the functions of proxy server 16 and data center 19 are performed by a single computing system. Moreover, the operations of reimbursement request system 10 may be performed by more, fewer, or other components. For example, the operations of tenant record request process 11, proxy server 16, and data center 19 may be performed by one component, or the operations of tenant record request process 11, proxy server 16, and data center 19 may be performed by more than one component. Additionally, operations of reimbursement request system 10 may be performed using any suitable logic comprising software, hardware, other logic, or any suitable combination of the preceding. As used in this document, “each” refers to each member of a set or each member of a subset of a set.

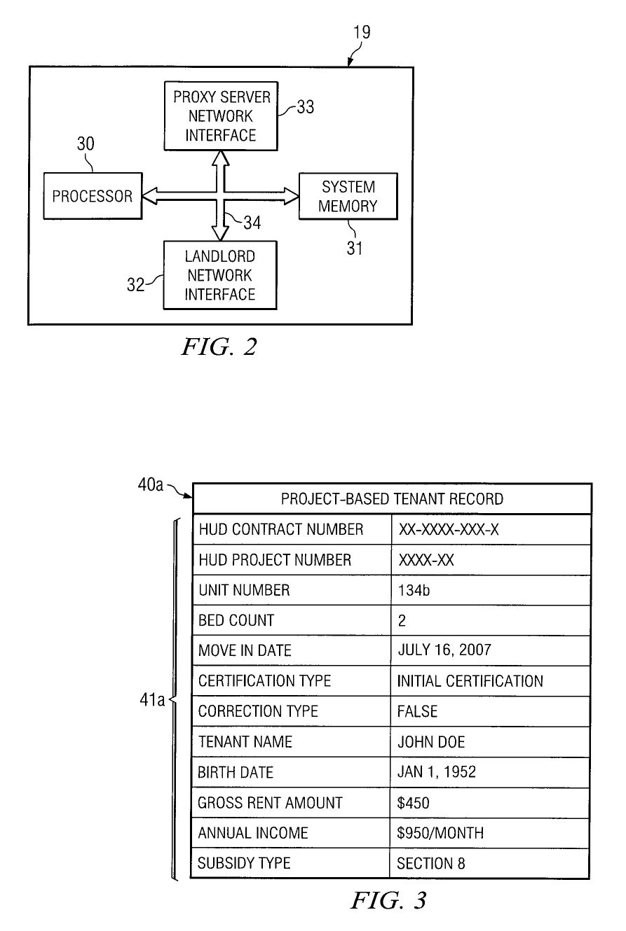

FIG. 2 is a block diagram of the data center of the embodiment of FIG. 1. Data center 19 generally comprises a processor 30, a proxy server network interface 33, a landlord network interface 32, and a system memory 31, which are coupled together via a bus 34. The proxy server network interface 33 may couple the data center 19 to the proxy server 16. Additionally, the landlord network interface 32 may couple the data center 19 to each of the landlord computers 21.

The system memory 31 may store executable instructions used by the processor 30 as well as data used by these executable instructions. For example, system memory 31 may store a set of executable instructions that implements dynamic content for each landlord instance 17, and the processor 30 may execute the set of executable instructions.

The system memory 31 can include any one or combination of volatile memory elements, such as random access memory (RAM), dynamic random access memory (DRAM), static random access memory (SRAM), or nonvolatile memory elements, such as read only memory (ROM), erasable programmable read only memory (EPROM), electronically erasable programmable read only memory (EEPROM), programmable read only memory (PROM), tape, compact disc read only memory (CD-ROM), disk, diskette, cartridge, or the like. Moreover, the system memory 31 may incorporate electronic, magnetic, optical, and/or other types of storage media.

FIGS. 3 through 10 illustrate examples of records that may be used with the embodiment of FIG. 1. In one embodiment, a record may comprise a digital record that may be organized in a data structure stored in database 18.

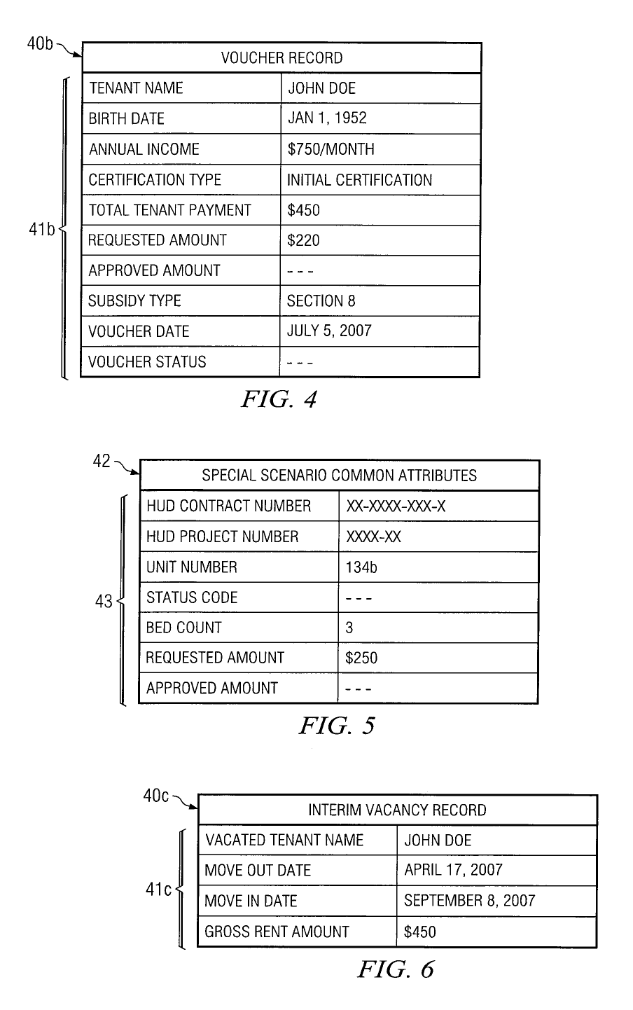

FIGS. 3 and 4 show examples of tenant records for different HUD reimbursement programs. A tenant record may include a number of attributes describing characteristics of the tenant that may be needed to request reimbursement from HUD. FIG. 3 shows one embodiment of a project-based tenant record 40a that may be used to request reimbursement under a project-based reimbursement program. FIG. 4 shows one embodiment of a voucher record 40b that may be used to request reimbursement under a voucher-based reimbursement program.

Under the project-based reimbursement program, the PBCA may enter into an assistance contract with the landlord for a predetermined number of residential housing units for a specified term. The PBCA refers tenants from its waiting list to the landlord in order to fill vacancies. Because the assistance is tied to the residential housing unit, a tenant who moves from the project-based residential housing unit does not have any right to continued housing assistance. Under the voucher-based reimbursement program, the PBCA issues an eligible tenant a voucher and the tenant selects a residential housing unit of its choice. If the tenant moves out of the residential housing unit, the contract with the landlord ends and the tenant can move with continued assistance to another unit.

The project-based tenant record 40a may include a number of attributes 41a that provide information about the tenant and other information to process a project-based reimbursement request. Attributes 41a such as a “HUD contract number” and a “HUD project number” indicate the specific contract that has been entered into with HUD and the residential housing unit of the contract. Attributes such as a “unit number”, “bed count”, “move in date”, and “gross rent amount” describe the residential housing unit for which reimbursement is sought. Other attributes such as “tenant name”, “birth date”, and “annual income” provide information about the tenant seeking assistance. Attributes such as “certification type”, “correction type”, and “subsidy type” provide information specific to the type of reimbursement sought.

The “certification type” attribute may provide information indicating verification of the tenant's eligibility to receive assistance. When the record 40a is transmitted from the landlord computer 21, the “certification type” attribute may indicate the periodic interval in which the tenant is seeking a certain amount of assistance. For example, the “certification type” attribute may include information such as initial, interim, or annual certification. When the record 40a is transmitted back from the PBCA 15 as a response, the “certification type” attribute may include information regarding acceptance of the current tenant record. For example, the “certification type” attribute may be populated with values, such as “submitted false information”, “did not recertify on time”, or other such information that may indicate the tenant's ability to receive a reimbursement.

The “correction type” attribute may include a value that indicates whether the record is being initially submitted or if the record is being submitted as a correction to an earlier request for reimbursement. The “subsidy type” attribute may indicate the type of subsidy sought and may include such values as “section 8”, “section 236”, “section 202 PRAC”, “section 811 PRAC”, and the like.

The voucher record 40b may include a number of attributes 41b that provide information about the tenant and other information to process a request for reimbursement under the voucher-based reimbursement program. The voucher record 40b may include attributes that provide information about the tenant, such as “tenant name”, “birth date”, and “annual income”. Other attributes, such as “certification type”, “requested amount”, “approved amount”, and “subsidy type”, provide information specific to the type of reimbursement sought. The voucher record 40b may also include a “voucher status” attribute that enables the landlord to check the status of any pending voucher. After filing a voucher for a landlord using the voucher record 40b, the landlord may check the status of the voucher at any time during pendency of the voucher with the PBCA 15.

FIGS. 5 through 10 illustrate examples of records that may be used for special scenarios. HUD provides reimbursement for special scenarios that may occur in the process of providing project-based housing by landlords. These special scenarios may include, but are not limited to, an interim vacancy of a residential housing unit scenario, a debt service scenario, an unpaid rent or damages scenario, a rent-up vacancy scenario, and a dual occupancy scenario.

FIG. 5 is an illustrative view an example of a set of common attributes that may be used with the records of FIGS. 6 through 9. A special scenario record may include a common attribute set 42. The common attribute set 42 has a plurality of common attributes 43 that may be used in conjunction with each of the special scenario records 40c through 40f.

The common attributes 43 may include information regarding the residential housing unit under which a specific contract has been entered into with HUD as well as other information pertinent to project-based assistance. For example, the attributes may comprise a “HUD contract number” and a “HUD project number” that provides contract information between HUD and the landlord. Attributes such as “unit number”, “request amount”, and “approved amount” may be included to provide information about the residential housing unit and the monetary reimbursement.

The common attribute set 42 may also include a “status code” attribute that may be used to check the status of any pending claim due to a special scenario. For example, the landlord may have encountered a damage scenario wherein a tenant has damaged a portion of a wall. Repairs for the damaged portion of the wall came to $2835. After filing a claim for the damages using the unpaid rent/damages record 40e, the landlord may check the status of the claim at any time during pendency of the claim with the PBCA 15.

FIGS. 6 through 9 illustrate, respectively, an interim vacancy record 40c, a debt service record 40d, an unpaid rent/damages record 40e, and a rent-up vacancy record 40f. In one embodiment, special scenario records 40c through 40f may be stored in the database 18 in an object-oriented form. The common attribute set 42 may be a parent base class of each of the special scenario records 40c through 40f. A special scenario record 40c through 40f may inherit the common attributes 43 from the common attribute set 42.

FIG. 6 shows an example interim vacancy record 40c that may be utilized to process a request for reimbursement due to an interim vacancy of a residential housing unit. An interim vacancy scenario may be encountered when a residential housing unit, which is under contract with HUD, remains unoccupied for a specified period of time. For example, a particular residential housing unit may have been under contract with HUD to provide subsidized housing assistance for a first tenant that has been residing at this residential housing unit.

When the first tenant moves out, the residential housing unit may remain unoccupied for a period of time until a second tenant is found. This period of time comprises a cost that is incurred by the landlord. Consequently, HUD provides monetary reimbursement for a portion of this incurred cost. To provide information regarding such a scenario, a “vacated tenant name”, “move out date”, “move in date”, and “gross rent amount” attributes may be included in the interim vacancy record 40c.

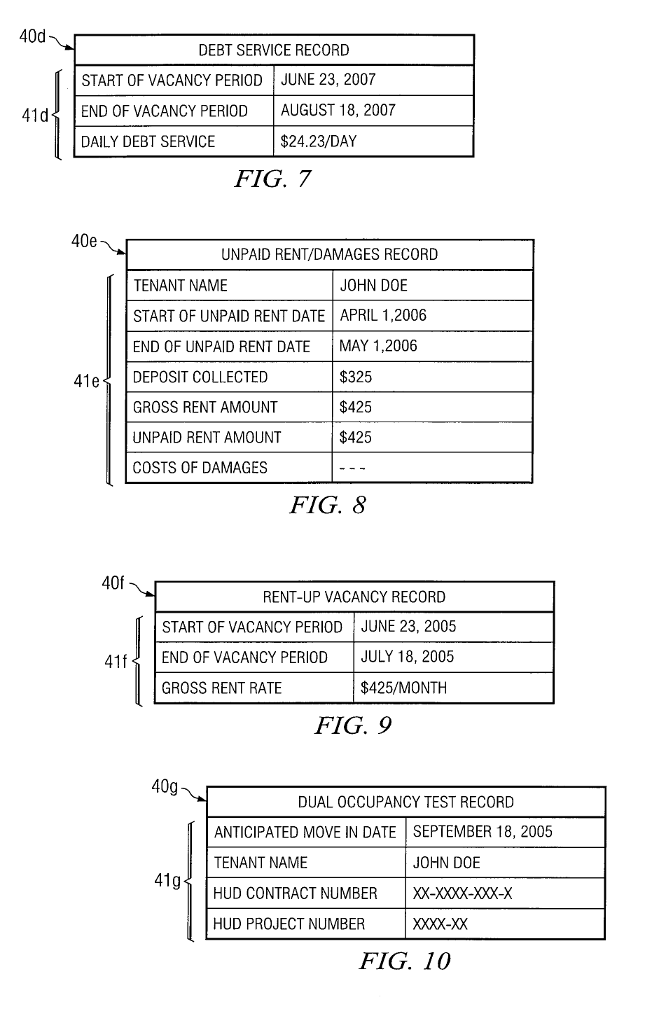

FIG. 7 shows an example debt service record 40d that may be used to request reimbursement in a debt service scenario. A debt service scenario may include costs incurred by loans that were obtained from a lending institution. The loans may have been provided for construction costs or by daily operating expenses incurred by the landlord. For example, a particular residential housing unit may be constructed under contract with HUD. In order to construct this unit, the landlord may have obtained a loan from a bank. The interest charged on this loan comprises a cost incurred by the landlord.

Monetary reimbursement may be provided by HUD to defray the costs incurred by the landlord. In the example, the landlord may be entitled to receive partial reimbursement due to interest charges from the bank. In the example debt service record 40d, attributes “start of vacancy period”, “end of vacancy period”, and “daily debt service” attributes may provide information in order to request reimbursement for a debt service scenario.

FIG. 8 shows one example of an unpaid rent/damages record 40e that may be used by the reimbursement request system 10 to request reimbursement in an unpaid rent or damages scenario. An unpaid rent scenario may be encountered when the tenant fails to adequately pay any portion of the rent during a specified rental period. The scenario typically occurs after the tenant has moved out of the property. Additionally, a damage scenario may be encountered if the residential housing unit has been damaged.

The unpaid rent/damages record 40e may include such attributes as “tenant name”, “start of unpaid rent date”, “end of unpaid rent date”, “deposit collected”, “gross rent amount”, “unpaid rent amount”, and “costs of damages”. For example, a tenant named John Doe has not paid back rent for the entire month of April, and the rental period for the residential housing unit extends from the first of each month. In such a case, the landlord would be able to seek monetary reimbursement from HUD. If the deposit amount collected from John Doe is only $325, the landlord may request reimbursement of the $100 difference not covered by the deposit.

As another example, a tenant may have damaged a portion of the residential housing unit. In this case, the “costs of damages” attribute may indicate a monetary amount sufficient to repair the damage. Thus, the unpaid rent/damages record 40e may allow the landlord to claim subsidies for unpaid rent as well as damages to the residential housing unit.

FIG. 9 shows an example of a rent-up vacancy record 40f that may be used to request reimbursement in a rent-up vacancy scenario. The rent-up vacancy scenario may be encountered by a provider of newly created residential housing. Following completion of construction of the residential housing, a period of time may elapse before the residential housing is fully occupied. Moreover, the latency period from when a residential housing unit is completed to the move in date presents a cost that may be incurred by the landlord.

HUD may provide an appropriate monetary reimbursement to subsidize this type of special scenario. To provide information for the rent-up vacancy scenario, the rent-up vacancy record 40f may include “start of vacancy period”, “end of vacancy period”, and “gross rent rate” attributes. In the example, a landlord initially constructs ten residential housing units under contract with HUD. Following construction, each of the residential housing units are available for occupancy. Immediately, nine of the residential housing units become occupied, yet the tenth one remains unoccupied for a period of twenty-eight days. The landlord may then use the rent-up vacancy record 40f to request reimbursement for the unoccupied residential housing unit for the twenty-eight day period.

FIG. 10 shows one embodiment of a dual occupancy test record 40g that may be used to test for the dual occupancy scenario. Claims for reimbursement from multiple residential housing units may present a problem for landlords. This problem may be encountered via willful fraud or inadvertent negligence on the part of the tenant. For example, a tenant may begin renting a second residential housing unit several days before canceling the first residential housing unit. In many cases, this is to allow for moving personal items such as home furnishings from the first residential housing unit to the second residential housing unit. Nevertheless, this type of scenario creates problems for the landlord. This scenario may generate a critical error during PBCA validation, which may hinder reimbursement. This problem is further complicated by the fact that the landlord may not have knowledge of the actual move out date of the tenant from the previous residential housing unit.

A dual occupancy test may provide a solution to this problem. The dual occupancy test enables the landlord to determine if a prospective tenant is receiving subsidies from another residential housing unit. The dual occupancy test record 40g may include several attributes 41g such as an “anticipated move in date”, “Tenant Name”, “HUD contract number”, and “HUD project number”. The “HUD contract number” and “HUD project number” attributes provide information regarding the residential housing unit under which a specific contract has been entered into with HUD. The “anticipated move in date” and “Tenant Name” attributes provide information about the particular tenant.

The record 40g may be submitted when the tenant applies for occupancy. The PBCA 15 may check to ascertain if the prospective tenant is attempting to claim subsidies for more than one residential housing unit during a particular period of time. The PBCA 15 may inform the landlord whether the tenant is currently receiving subsidized housing from another landlord. Thus, the reimbursement request system 10 may enable the landlord to alleviate problems associated with dual occupancy of a residence.

A project-based tenant record 40a and a voucher record 40b, as well as the five different types of special scenario records 40c through 40g have been described above. However, it should be appreciated that other types of records, which may be associated with other types of reimbursement scenarios, would fall within the scope of the present invention. Furthermore, it should be understood that the plurality of attributes of each of the records 40 do not each comprise an exhaustive list of attributes that may be associated with each record; however, only several of all possible attributes are disclosed for the purposes of brevity and clarity of disclosure.

The reimbursement request system 10 may be operable to utilize the previously described records 40 to request monetary reimbursement from one or more PBCAs 15. According to one embodiment, the reimbursement request system 10 may be used to monitor the monetary reimbursement amount for a particular tenant record 40 stored in the landlord computer 21. For example, records of a tenant may be itemized by the “approved amount” attribute to establish the total reimbursement amount due from HUD. Thus, the total reimbursement amount due from HUD for each reporting period may be itemized to each tenant.

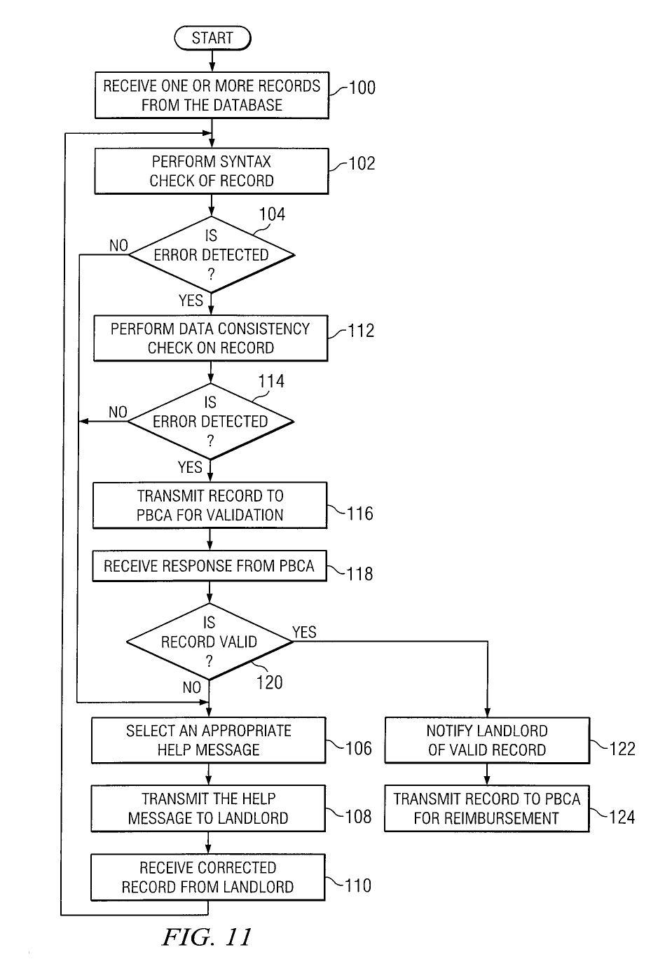

FIG. 11 shows a method that may be utilized by one embodiment of the reimbursement request system 10. At step 100, the data center 19 may receive one or more records 40 from the database 18. The data center 19 may then perform a syntax check at step 102 to verify that each of the included attributes 41 has proper format and syntax. The data center 19 may also verify that each of the attribute values contain the proper variable type and other aspects of the value such as a proper number of characters. For example, the data center 19 may check to ensure that the bed count attribute contains an integer value that may be, for example, between “1” and “5”.

If an error is detected at step 104, the data center 19 may select a particular help message at step 106 corresponding to the type of error detected. For example, the data center 19 may select a help message indicating the incorrect attribute and may include allowable values for the attribute. At step 108, the data center 19 may transmit the help message that indicates the particular incorrect attribute value to the landlord computer 21. At step 110, the system receives a corrected attribute from the landlord. The method then returns to step 102, where the record 40 is checked again.

If no errors are detected at step 104, the data center 19 may then perform a data consistency check the attributes of the record 40 at step 112. The data consistency check may verify several of the attribute values of an attribute against known reasonable values of the attribute. For example, an attribute value indicating a date of Jan. 41, 2040 may be considered unreasonable and thus would be determined to be an error.

If the data center 19 detects a data consistency error at step 114, an appropriate help message is selected based upon the type of error at step 106. For errors such as syntax errors or data consistency errors, the data center 19 may select a help message that indicates the particular incorrect attribute value and possible correct values for the attribute. For the above example, the help message may include the alpha-numeric phrase “Please correct the ‘start of vacancy period date’.” The data center 19 transmits the help message to the landlord at step 108. At step 110, the data center 19 may receive a corrected record 40 in which processing resumes at step 102.

If the data consistency check does not detect any errors at step 114, the record 40 may be transmitted to the appropriate PBCA 15 for validation at step 116. The data center 19 may store mappings of contract numbers to their appropriate PBCAs 15, and identify the appropriate PBCA 15 for a record 40 from the “HUD contract number” attribute of the record 40. In one embodiment, the record 40 may be in a format compliant with a Tenant Rental Assistance Compliance System (TRACS) message. TRACS messages generally comprise a standardized format for the receipt and transmission of tenant information. In step 118, a response is received from the PBCA 15. The response may also include one or more error messages. An error message may include information such as “ineligible citizenship”, “did not recertify on time”, “submitted false information”, “landlord's contract expired”, and the like.

Error messages may classify an error as critical or non-critical. An error may be classified as critical if the error prevents full monetary reimbursement. The error must be corrected to receive full reimbursement from HUD. In this case, no or partial payment from HUD may be received for the record 40. In one example, a critical error may occur when a tenant claims elderly status when the tenant is not elderly. Section 202 of the United States Housing Act of 1959 specifies the minimum age at which elderly status is a consideration for subsidized housing. The PBCA 15 may verify the birth date of the tenant using the “birth date” attribute. If the minimum age requirement is not met, a critical error message will be generated as a response to the record 40.

An error may be classified as non-critical if the error is not sufficient to hinder reimbursement for that particular tenant. For example, HUD regulations may cite that a residential housing unit shall not have more than 1.5 tenants per bedroom. Although this regulation may serve the purpose of minimizing complications inherent with an overcrowded residence, violation of this requirement may only create a non-critical error message during the validation process.

If the response from the PBCA 15 includes an error message at step 120, the data center 19 may select an appropriate help message from a set of help messages stored in system memory 31 at step 106. Error messages from PBCAs 13 generally do not provide explanatory information about the error. The help message may be selected based upon pertinence of the help message to the error message and other factors. Other pertinent factors may include recent rule changes promulgated by HUD, past history of the tenant, or other conflicting attributes in the record 40. For example, the error message may indicate that the tenant did not recertify on time. In such a case, the data center 19 would choose a help message explaining the belated recertification as well as other attribute values of the record, such as move in date, or last certification date that would potentially determine the root cause of the error.

If the record 40 has been validated as correct at step 120, the data center 19 notifies the landlord that the record 40 has been correctly validated at step 122. Once the one or more records 40 have been correctly validated by the system 10, the records 40 may then be transmitted to the PBCA computer 14 for reimbursement at step 124.

The previously described procedure may be performed at predetermined periodic intervals in order to request monetary reimbursement from the PBCA 15. The predetermined periodic interval may be associated with a rental payment period such as a particular day or plurality of days each month when the request for payment is due. For example, the previously described procedure may be performed during the rental payment period to ensure that proper monetary reimbursement for each tenant is properly assessed from the PBCA 15 for that particular month.

In one embodiment, the method may be used in a data synchronization process to verify the consistency of the records without actually requesting monetary reimbursement from the PBCA. In this manner, users of the landlord computer 21 may be able to continually monitor changes that may take place in their tenant's status as well as to monitor changes that may occur in the administrative guidelines regarding their tenant's status at the PBCA 15.

To perform the data synchronization process, a data synchronization indication may be transmitted to the PBCA computer 14 to indicate that the attributes of one or more subsequent records 40 are to be verified for consistency without requesting monetary reimbursement. In one embodiment, the data synchronization indication is a message that is transmitted from the data center 19 to the PBCA computer 14 and may remain active until another data synchronization indication message is transmitted to the PBCA computer 14 or an active session established between the data center 19 and the PBCA computer 14 is canceled. This data synchronization process differs from step 124 however, in that the PBCA computer 14 does not instruct the PBCA 15 to perform an actual monetary reimbursement for the records 40 that are received during this process.

It will be apparent that many modifications and variations may be made to embodiments of the present invention, as set forth above, without departing substantially from the principles of the present invention. Therefore, all such modifications and variations are intended to be included herein within the scope of the present invention, as defined in the claims that follow.

What is claimed is:

1. A server for validating one or more records associated with a corresponding one or more tenants, comprising:
an interface in communication with a first computer associated with a landlord, the interface in communication with a second computer associated with a performance based contract administrator, the interface operable to:
receive a record of the one or more records from the first computer;
transmit the record to the second computer for validation;
receive a response from the second computer; and
one or more processors operable to:
if the response includes an error message, select a help message from among a plurality of help messages in accordance with pertinence of the help message to the error message.

2. The server of claim 1, wherein the record is selected from the group consisting of a project-based tenant record, a voucher record, an unpaid rent/damages record, a debt service record, a rent-up record, a dual occupancy test record, and an interim vacancy record.

3. The server of claim 1, wherein:
the one or more tenants comprises a plurality of tenants;
the response comprises an approved reimbursement amount for each of the plurality of tenants; and
the one or more processors further operable to:
sum the approved reimbursement amounts to calculate a total reimbursement amount.

4. The server of claim 1, wherein the one or more processors are further operable to select the help message by:
performing a syntax check on the record; and
if the syntax check detects a syntax error, selecting the help message in accordance with pertinence of the help message to the syntax error.

5. The server of claim 1, wherein the one or more processors are further operable to select the help message by:
performing a data consistency check on the record; and
if the data consistency check detects a data consistency error, selecting the help message in accordance with pertinence of the help message to the data consistency error.

6. The server of claim 1, wherein the one or more processors are further operable to request reimbursement by:
associating the record with an approved reimbursement amount; and
transmitting the record with the approved reimbursement amount to the second computer for reimbursement.

7. The server of claim 1, wherein the one or more processors are further operable to perform a data synchronization process by:
transmitting a data synchronization indication to the second computer, the data synchronization indication indicating that the record is independent of a reimbursement request.

8. The server of claim 1, wherein the second computer is operable to:
identify a tenant associated with the record;
establish whether the tenant is requesting reimbursement for more than one housing unit; and
include a notification in the response if the tenant is requesting reimbursement for more than one housing unit.

9. The server of claim 1, wherein the one or more processors are further operable to transmit the help message to the first computer using an interactive messaging process.

10. The server of claim 1, wherein the response comprises a Tenant Rental Assistance Compliance System (TRACS) message.

11. A method for validating one or more records associated with one or more tenants by a server that is coupled to a data network, comprising:
receiving a record of the one or more records from a first computer associated with a landlord;
transmitting the record to a second computer associated with a performance based contract administrator for validation;
receiving a response from the second computer; and
if the response includes an error message, selecting a help message from among a plurality of help messages in accordance with pertinence of the help message to the error message.

12. The method of claim 11, wherein selecting the help message further comprises:
performing a syntax check on the record; and
if the syntax check detects a syntax error, selecting the help message in accordance with pertinence of the help message to the syntax error.

13. The method of claim 11, wherein selecting the help message further comprises:
performing a data consistency check on the record; and
if the data consistency check detects a data consistency error, selecting the help message in accordance with pertinence of the help message to the data consistency error.

14. The method of claim 11, wherein the record is selected from the group consisting of a project-based tenant record, a voucher record, an unpaid rent/damages record, a debt service record, a rent-up record, a dual occupancy test record, and an interim vacancy record.

15. The method of claim 11, wherein the performance based contract administrator is a plurality of performance based contract administrators and each of the plurality of performance based contract administrators have a plurality of administrative guidelines that differ from one another, the help message including information that conforms to the plurality of administrative guidelines of the performance based contract administrator.

16. The method of claim 11, further comprising requesting monetary reimbursement from the second computer.

17. The method of claim 11, further comprising:
identifying a tenant associated with the record;
establishing whether the tenant is requesting reimbursement for more than one housing unit; and
including notification in the response if the tenant is attempting to claim subsidies for the more than one housing unit.

18. The method of claim 11, wherein:
the one or more tenants comprises a plurality of tenants;
the response comprises an approved reimbursement amount for each of the plurality of tenants; and
the method further comprising:
summing the approved reimbursement amounts to calculate a total reimbursement amount.

19. The method of claim 11, wherein transmitting a help message to the first computer further comprises transmitting the help message to the first computer using an interactive messaging process.

20. The method of claim 11, wherein the response comprises a Tenant Rental Assistance Compliance System (TRACS) message.

21. The method of claim 11, wherein the help message is selected from among a plurality of help messages in accordance with pertinence of the help message to the error message, past history of the tenant, recent rule changes in HUD, or other conflicting information provided in the record.

22. Code embodied in a computer readable medium, when executed by a computer operable to:
receive a record of one or more records from a first computer associated with a landlord, each of the one or more records associated with a corresponding one or more tenants;
transmit the record to a second computer associated with a performance based contract administrator for validation;
receive a response from the second computer; and
if the response includes an error message, select a help message from among a plurality of help messages in accordance with pertinence of the help message to the error message.

23. The code of claim 22, further operable to select the help message by:
performing a syntax check on the record; and
if the syntax check detects a syntax error, selecting the help message in accordance with pertinence of the help message to the syntax error.

24. The code of claim 22, further operable to select the help message by:
performing a data consistency check on the record; and
if the data consistency check detects a data consistency error, selecting the help message in accordance with pertinence of the help message to the data consistency error.

25. The code of claim 22, wherein the record is selected from the group consisting of a project-based tenant record, a voucher record, an unpaid rent/damages record, a debt service record, a rent-up record, a dual occupancy test record, and an interim vacancy record.

26. The code of claim 22, further operable to select the help message by:
selecting the help message from among a plurality of help messages in accordance with pertinence of the help message to the error message.

27. The code of claim 22, wherein:
the one or more tenants comprises a plurality of tenants;
the response comprises an approved reimbursement amount for each of the plurality of tenants; and
the code further operable to:
sum the approved reimbursement amounts to calculate a total reimbursement amount.

28. The code of claim 22, further operable to request reimbursement by:
associating the record with an approved reimbursement amount; and
transmitting the record with the approved reimbursement amount to the second computer for reimbursement.

29. The code of claim 22, further operable to perform a data synchronization process by:
transmitting a data synchronization indication to the second computer, the data synchronization indication indicating that the record is independent of a reimbursement request.

30. The code of claim 22, wherein the second computer is operable to:
identify a tenant associated with the record;
establish whether the tenant is requesting reimbursement for more than one housing unit; and
include notification in the response if the tenant is requesting reimbursement for more than one housing unit.

31. The code of claim 22, further operable to transmit the help message to the first computer using an interactive messaging process.
